(19) United States
(12) Patent Application Publication
(10) Pub. No.: US 2016/0025071 A1
(43) Pub. Date: Jan. 28, 2016

(54) METHOD OF COMPUTING THEORETICAL POWER OF WIND FARM BASED ON SAMPLE WIND TURBINE METHOD

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); MING MA, Beijing (CN); QING-QUAN LV, Beijing (CN); YAN-HONG MA, Beijing (CN); GUANG-TU LIU, Beijing (CN); HUAI-SEN JIA, Beijing (CN); LONG ZHAO, Beijing (CN); ZI-FEN HAN, Beijing (CN); QIANG ZHOU, Beijing (CN); DING-MEI WANG, Beijing (CN); LIANG LU, Beijing (CN); JIAN-MEI ZHANG, Beijing (CN)

(21) Appl. No.: 14/809,284

(22) Filed: Jul. 27, 2015

(30) Foreign Application Priority Data
Jul. 28, 2014 (CN) 201410360594.7

(51) Int. Cl. F03D 11/00; G01W 1/10

(52) U.S. Cl. CPC F03D 11/0091; G01W 1/10

(57) ABSTRACT

A method of computing theoretical power of wind farm based on sample wind turbine method. Historical real-time measured output data of sample wind turbines in the wind farm is statistically analyzed. A theoretical output of the sample wind turbines is analyzed based on a wind power output characteristic and a theoretical output design curve of wind turbine. A theoretical power calculation model of wind farm is constructed based on the historical real-time measured output data of sample wind turbines. A number of wind turbines actually running in real-time is obtained based on real-time information data of wind turbines in the wind farm. An actual operation data of the sample wind turbines is confirmed. The actual operation data is input into the theoretical power calculation model of wind farm. Real-time data of theoretical power of wind farm is output, and an actual operation result of wind farm is comparatively analyzed.

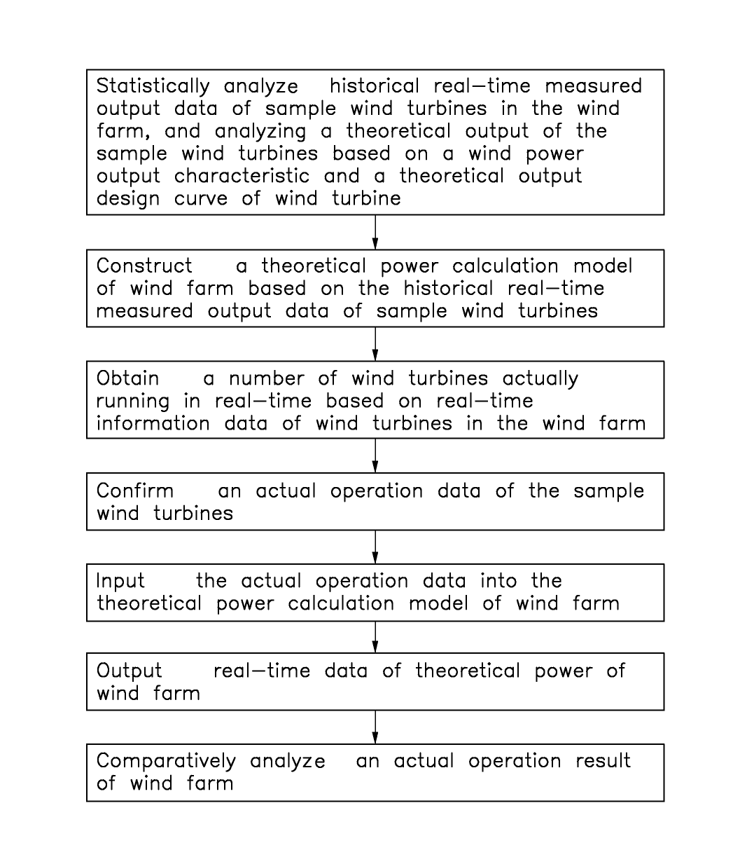

This application claims all benefits accruing under 35 U.S.C. §119 from China Patent Application 201410360594.7, filed on Jul. 28, 2014, in the China Intellectual Property Office, disclosure of which is incorporated herein by reference.

### BACKGROUND

1. Technical Field

The present disclosure relates to a method of computing theoretical power of wind farm based on sample wind turbine method.

2. Description of the Related Art

With the rapid development of wind power industry, China has entered a period of rapidly developing wind power. Large-scale wind power bases are usually located in the “Three North” (Northwest, Northeast, Northern China) of China.

On Jan. 1, 2006, “Renewable Energy Law” is promulgated and provides guarantee and new impetus for the development of wind power. China wind power has entered a phase of large-scale development, and “building large bases and access to a large grid” has become the main mode of development of wind power. By the end of 2012, China total installed capacity is about 75324.2MW, accounting for 26.7% of the world, and ranking the first in the world.

Large-scale wind power gives a great deal of pressure to the peak load regulation. Because of the limitation of peaking capacity and grid structure, a plurality of wind power bases abandon wind power and ration power. At present, the wind power network in particular wind power abandonment and wind power ration have become the focus of attention. The calculation of theoretical power and electric energy of the wind farm, and assessing abandoned wind power, has important significance to the contradiction between network and plant, and promote the sound development of the wind power industry.

The Wind Farm theory refers to the maximum power output under actual wind speed, and considering wake effects, downtime, plant consumption, transmission losses, and other factors. Due to large-scale wind power centralized and network, long-distance transport, high voltage requirement, China wind power shows significant difference over the foreign wind power development mode. The grid technology and economic problems is more complex. Most wind power base at remoteness district experiences sent bottlenecks, and the power ration is a serious problem. Because the power of wind farms can not be accurately predicted, thus the efficiency of wind power is low, and result other issues such as impact on the grid.

With development of new energy, uncertainty and uncontrollability of wind power and photovoltaic brings to many problems to the security and stability of economic operation of the grid. The wind power predication is the basis for large-scale wind power optimization scheduling. The wind power predication can provide critical information for real-time scheduling of new energy, recent plan of new energy, monthly plan of new energy, generation capacity of new energy, and abandoned wind power

What is needed, therefore, is a method of computing theoretical power of wind farm.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The only FIGURE shows a flowchart of one embodiment of a method of computing theoretical power of wind farm based on sample wind turbine method.

### DETAILED DESCRIPTION

The disclosure is illustrated by way of example and not by way of limitation in the FIGURE of the accompanying drawings in which like references indicate similar elements. It should be noted that references to “an” or “one” embodiment in this disclosure are not necessarily to the same embodiment, and such references mean at least one.

Referring to the FIGURE, one embodiment of a method of computing theoretical power of wind farm based on sample wind turbine method comprises:

first step, statistically analyzing historical real-time measured output data of sample wind turbines in the wind farm, and analyzing a theoretical output of the sample wind turbines based on a wind power output characteristic and a theoretical output design curve of wind turbine;

second step, constructing a theoretical power calculation model of wind farm based on the historical real-time measured output data of sample wind turbines;

third step, obtaining a number of wind turbines actually running in real-time based on real-time information data of wind turbines in the wind farm;

fourth step, confirming an actual operation data of the sample wind turbines;

fifth step, inputting the actual operation data into the theoretical power calculation model of wind farm; and

sixth step, outputting real-time data of theoretical power of wind farm, and comparatively analyzing an actual operation result of wind farm.

In the first step, the sample wind turbines can be selected as follows. No more than 10% of the wind turbines in the wind farm are chosen as the sample wind turbines. The sample wind turbines are uniformly distributed according to geography and topography. The sample wind turbines belongs to different models and different capacity, and accurately reflects the actual power generation capacity of wind farm. While one of the sample wind turbines is failure, an adjacent wind turbine will be selected to substitute it.

The method of computing theoretical power of wind farm is based on a number of historical data of the plurality of sample wind turbines, adopts interpolation method, and statistical and mathematical method to pre-treat the historical data, constructs theoretical power calculation model through the sample wind turbines, and takes the wake effects and the actual operation of wind farm in account.

In embodiment, the method comprises following steps.

(1) selecting sample wind turbines, wherein no more than 10% of the wind turbines in the wind farm are selected as the sample wind turbines.

The sample wind turbines are uniformly distributed according to geography and topography. The sample wind turbines belongs to different models and different capacity, and accurately reflects the actual power generation capacity of wind farm.

While one of the sample wind turbines is failure, a adjacent wind turbine is selected to substitute it, and reported to the power dispatching agencies. The sample wind turbines should also be selected according to the topography, geographical distribution of wind turbines, electrical wiring manner, and feed wind turbine distribution.

(2) statistical analyzing the theoretical output law of wind turbine through the historical data of the sample wind turbines, and constructing theoretical output model of wind farm.

(3) inputting the real-time data into the theoretical output model of farm to calculate the real-time theoretical power.

The method has following advantages. The method analyzes the long-term output characteristic of wind turbines in wind farm, takes historical output data of sample wind turbines as basis, adopts interpolation method and statistical and mathematical method to pre-treat the historical output data, constructs theoretical power calculation model based on the sample wind turbines. The method has important practical value.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of computing theoretical power of a wind farm based on sample wind turbine method, the method comprising:
statistically analyzing historical real-time measured output data of sample wind turbines in the wind farm, and analyzing a theoretical output of the sample wind turbines based on a wind power output characteristic and a theoretical output design curve of wind turbine;
constructing a theoretical power calculation model of the wind farm based on the historical real-time measured output data of the sample wind turbines;
obtaining a number of wind turbines actually running in real-time based on real-time information data of wind turbines in the wind farm;
confirming an actual operation data of the sample wind turbines;
inputting the actual operation data into the theoretical power calculation model of the wind farm; and
outputting real-time data of theoretical power of the wind farm, and comparatively analyzing an actual operation result of the wind farm.

2. The method of claim 1, wherein the sample wind turbines are selected as follows:
no more than 10% of a plurality of wind turbines in the wind farm are chosen as the sample wind turbines;
the sample wind turbines are uniformly distributed according to geography and topography;
the sample wind turbines have different models and different capacity, and accurately reflect the actual power generation capacity of the wind farm; and
while one of the sample wind turbines is failure, an adjacent wind turbine will be selected to substitute the one of the sample wind turbines.
